(19) United States
(12) Patent Application Publication
(10) Pub. No.: US 2008/0316056 A1
(43) Pub. Date: Dec. 25, 2008

(54) Vehicle Garage Parking and Stopping Guide

(75) Inventor: Parijat Ghatak, East Brunswick, NJ (US)

Correspondence Address: Parijat Ghatak, 12 McGinnis Street, East Brunswick, NJ, 08816, US

(73) Assignee: TRACKER LLC, East Brunswick, NJ (US)

(21) Appl. No.: 11/764,901

(22) Filed: Jun. 19, 2007

(51) Int. Cl. B60Q 1/48

(52) U.S. Cl. 340/932.2

(57) ABSTRACT

A multi-sensory parking guidance system using visual, auditory and tactile feel indicators to guide a driver into an optimal position to park a vehicle. The invention also indicates the appropriate stopping position within a parking space.

The present invention relates to among other things, a device and method of guiding a motor vehicle into a confined space and stopping at a set end point. The device has a multi-sensory guidance system providing feedback indicators to help align the vehicle into the desired position.

In the prior art various types of parking devices have been proposed. For example, U.S. Pat. No. 7,021,237 to Benjamin discloses a parking guide using both visual and auditory indicators to show a driver when a vehicle is properly positioned in a parking space. The invention is comprised of a floor mat, walls, and bell activator among other features to facilitate the process.

U.S. Pat. No. 6,853,313 to Newcomer uses a set of light rays to help position the vehicle in the proper position.

U.S. Pat. No. 6,154,150 to Laubach discloses a projection unit mounted above a parking position, which projects a beam of light onto the parking position. A detection unit detects the light and a motion detector actuates the projector.

U.S. Pat. No. 5,285,205 to White uses a laser that emits a beam over the path a vehicle is to take to guide the driver position into position.

U.S. Pat. No. 5,127,357 to Viskovick discloses a mirror affixed adjacent a garage door which reflects the vehicles brake lights and rear bumper.

U.S. Pat. No. 4,813,758 to Sanders discloses a metal plate mounted with a fastener to a supporting surface and lateral positioning members for ensuring proper lateral vehicle positioning.

U.S. Pat. No. 4,665,378 to Heckethorn discloses a signal light downwardly in a concentrated beam to enable proper vehicle positioning.

Garage parking guides have been in use for years. Typically, garage parking guides are comprised of either physical levels, electrical connections or hanging devices that activate on visual and/or audible signals. Previous and current garage parking guides have required precise installation and adjustment for a particular vehicle, and/or driver.

The main problem with conventional garage parking guides is that the positioning a vehicle in an enclosed garage requires attention and precision. Parking a vehicle in a confined space requires, but is not limited to, the following conditions:
Vehicle must be parked to allow clearance for the garage door to close. The clearance should be at a minimum.
Vehicle should be parked to permit maximum use of garage space for storage of tools, lawn equipment and other household items.
Driver should allow space for movement around the vehicle.
Driver must also avoid hitting internal walls and other objects in the garage that may lead to damage of structure, equipment and/or vehicle. Particular concern needs to be placed in order to avoid damage to side view mirrors.
Vehicle should able to enter and exit garage with ease and meet the conditions stated above.

A simple but effective garage guide is needed to provide the driver with a signal to let the driver know when he or she has reached the proper location in which to park. The guide should be universal so that it will work for any size vehicle in any size garage. As long as there is physical space to park the vehicle in the garage, the guide should enable accurate parking each and every time. The invention should have a stopping guide to signal the driver the proper position has been reached to meet conditions stated above. The guide should provide frequent feedback to the driver during the entire parking process to achieve the desired outcome and park with confidence. The guide should be small in profile as possible to avoid being a tripping hazard, an eyesore and reduce the amount of consumed space. The guide should be easy to assemble requiring no tools. The guide should be inexpensive to manufacture and purchase to benefit as many drivers as possible. The guide should be easy to maintain and durable. The guide should be of modular design such that all parts should be replaceable.

Conventional garage parking guides for the most part with the exception that of Benjamin (U.S. Pat. No. 7,021,237) are better suited as stopping guides which help the driver stop the vehicle in a designated parking space versus actually guiding the vehicle into the garage—a much more difficult problem. Many use lasers or beams of light which are difficult to see during the day and therefore generally effective only at night. Conventional garage parking guides have physical signal producing devices that interfere with use of garage space. They can be unsightly and require high maintenance. As in the case of Benjamin (U.S. Pat. No. 7,021,237), they consume too much space and pose a tripping hazard with the raised walls. The audible signal devices are often irritating to the household and neighborhood, and they are expensive.

This invention, in general, to devices which assist in parking a vehicle in a garage, and, in particular, to floor guides which have an auditory, visual and tactile feel guide for proper placement of a vehicle in a garage or other parking space.

### SUMMARY OF THE INVENTION

The present invention is directed to a parking guide having visual, auditory and tactile feel indicators to guide the driver into a parking space and/or garage. The invention also has a stopping guide to signal the driver to stop the vehicle when the vehicle is properly positioned in a parking space.

In certain embodiments, the invention provides a new and improved parking guide

In certain embodiments, the invention provides a new and improved parking guide, which has visual, auditory, and tactile feel parking indicators.

In certain embodiments, the invention provides a new and improved parking guide, which can be easily and quickly assembled and used for any size vehicle in any size garage assuming there is physical space to park the vehicle in the garage.

In certain embodiments, the invention provides a new and improved parking guide that both guides the driver into the garage and stops the vehicle in the appropriate place in a parking space.

In certain embodiments, the invention provides a vehicle parking guide that signals to a vehicle driver appropriate entry into a parking spot and a parking end point comprising: an adjustable length floor mat comprising interlocking segments which include a segment with a start sensor and a segment with an end sensor, wherein the start segment is adapted to be positioned toward an entry point for the vehicle, and the end segment adapted to be positioned at the finishing point; and a sounding device with connections for connecting to the sensors, the sounding device and sensors operating to create a sound audible when vehicle wheels pass over the start sensor to indicate to the driver correct entry and when vehicle wheels reach the end sensor to indicate the vehicle reaching the end point. For the Summary: The invention provides, among other things, A vehicle parking guide that signals to a vehicle driver appropriate entry into a parking spot and a parking end point comprising: an adjustable length floor mat comprising interlocking segments which include a segment with a start sensor and a segment with an end sensor, wherein the start segment is adapted to be positioned toward an entry point for the vehicle, and the end segment adapted to be positioned at the finishing point; and a sounding device with connections for connecting to the sensors, the sounding device and sensors operating to create a sound audible when vehicle wheels pass over the start sensor to indicate to the driver correct entry and when vehicle wheels reach the end sensor to indicate the vehicle reaching the end point

In certain embodiments, the invention provides a method of parking using the parking guide, comprising aligning one of the front wheels with the parking guide; aligning the vehicle with the parking guide and driving forward; hearing the start sound as the aligned front wheel passes over the start sensor; maintaining the aligned orientation and driving until the driver hears the end sensor.

In certain embodiments, the invention provides a method of reversing a car out of a parking space while avoiding obstacles using the parking guide with bumps, comprising: providing a vehicle parked on the parking guide with two of its wheels on one side aligned with the parking guide; reversing the vehicle maintaining wheel alignment with the parking guide; feeling a tactile feel as the vehicle wheels contact the bumps, thereby confirming the maintenance of correct alignment; and hearing the sound as the aligned front wheel activates the start sensor, further confirming alignment.

These and other features and advantages of embodiments the present invention will be fully apparent from the following description, when taken in connection with the included drawings.

### BRIEF DESCRIPTION OF THE DRAWINGS

FIG. 1 is a perspective view of the present invention.

FIG. 2 is a detailed view of the start segment of the floor mat comprising of a pneumatic tube, tube guides and female connecting notches.

FIG. 3 is a detailed view of a middle segment of the floor mat comprising of a speed bump, tube guard, protected tube, female connecting notches and male connecting notches.

FIG. 4 is a detailed view of the end segment of the floor mat comprising of a pneumatic tube, tube guides, and male connecting notches.

FIG. 5 is a partial view of the present invention showing the bell ringing mechanism.

### DETAILED DESCRIPTION OF THE INVENTION

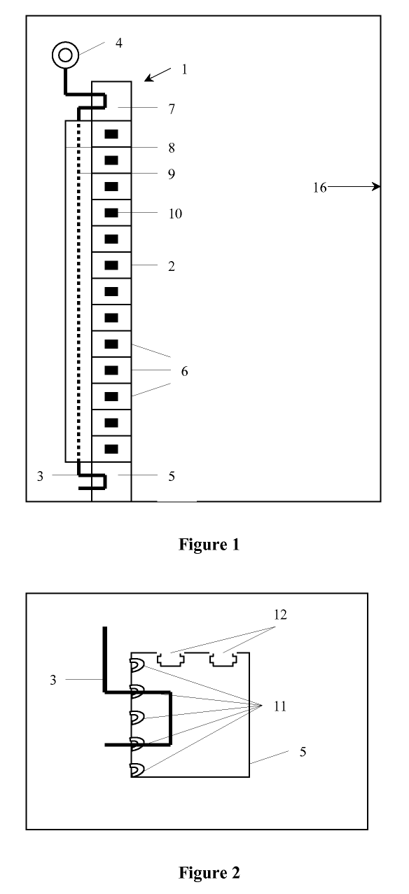

Referring now to the drawings in greater detail, FIG. 1 shows a perspective view of an exemplary parking guide of the present invention 1. The parking guide is comprised of three basic components: an adjustable length floor mat 2, pneumatic tube 3 and pneumatic sensing sounding bell 4. The layout of the parking guide on the garage floor 16 is illustrated in FIG. 1. The adjustable length floor mat 2 can be adjusted to fit any size vehicle in any size garage. The mat is comprised of three types of segments (start, middle, end) that interlock and connect to provide the variable length. The start segment 5 can have tube guides 11 to securely hold the pneumatic tube 3 in place to signal the driver that the vehicle is aligned properly and female connecting notches 12 to connect the start segment 5 to the middle segment 6. The middle segment 6 can vary in number of segments to meet the length of the vehicle and garage. It can be comprised of a tube guard 8, protected pneumatic tube 9, speed bump 10, female connecting notches 12 and male connecting notches 13. The middle segment securely connects to the start segment 5 and the adjacent middle segment 6. The middle segment 6 also securely connects to the adjacent middle segment 6 and to the end segment 7. The end segment 7 can be comprised of tube guides 11 to securely hold the pneumatic tube 3 in place at the appropriate vehicle stopping position. The end segment 7 also has male connecting notches to securely attach to the adjacent middle segment 6.

The parking guide is comprised of a pneumatic tube 3, which serves as the auditory sensor in both the start segment 5 and end segment 7. The parking guide includes a battery operated pneumatic sensing sounding bell 4, which generates an audible ring to signal the drive. The bell 4 has a tube connector 14 to connect to the pneumatic tube 3.

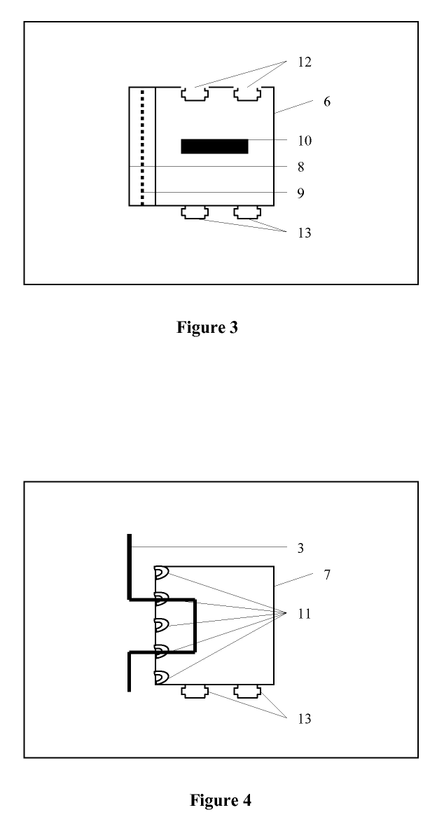

The driver initially places the adjustable length floor mat 2 in the appropriate position in the garage given the size of the vehicle, garage walls and desired stopping position. After which the driver secures the pneumatic tube 3 in the start segment 5 using the tube guides 11 (FIG. 2) and protects the tube using the tube guard 8 in the middle segments 6 (FIG. 3). This avoids false bell sounds. The driver then secures the pneumatic tube 3 in the end segment 7 at the desired stopping position using the tube guides 11 (FIG. 4). Finally the driver connects the end of the pneumatic tube 3 to the tube connector 14 on the bell 4 and hangs the bell on the wall.

As the driver approaches the garage he uses the adjustable length floor mat 2 as a visual guide to properly align the vehicle to the appropriate left/right orientation of the garage opening. If alignment is true the vehicle's front tire will drive over the pneumatic tube 3 located in the start segment 5, which is placed closely to the opening of the garage. Immediately, the bell 4 will ring providing an audible indicator that the alignment is true and it is safe to proceed. The vehicle tires will then make contact with the middle segments 6, which has a speed bump 10 in each segment. The speed bump 10 provides tactile feel to the driver that he is still on the mat, aligned correctly and it is safe to proceed. The tube guard 8 protects the pneumatic tube and prevents the bell from sounding while the vehicle is crossing the middle segments 6. Next the rear tires of the vehicle will cross the pneumatic tube 3 in the start segment 5 resulting in the bell 4 to ring for the second time. This signals the driver it is safe to proceed and the alignment is still true. Finally, the vehicle's front tires cross the pneumatic tube 3 in the end segment 7 resulting in the bell 4 to ring for the third time. The third bell ring signals the driver to stop. (The sounding of three or two bells depending on the car, and the placement of the parking guide.)

The driver can easily exit the garage simply by following the process in reverse. Exiting the garage though not as difficult as entry can be challenging due to the tight spaces involved.

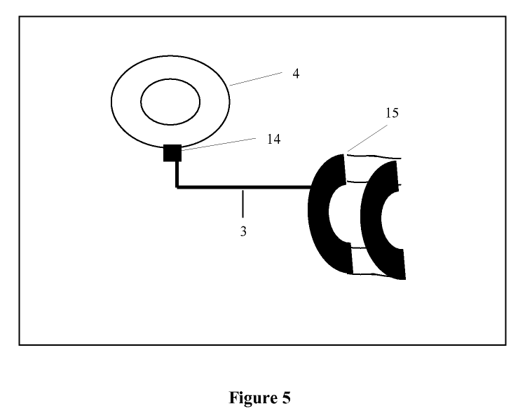

FIG. 5 shows the process of the vehicle tire 15 crossing the pneumatic tube 3 which occurs on the start segment 5 twice and the end segment 7 once upon entry.

It is envisioned that the driver would use one unit comprising of an adjustable length floor mat 2, pneumatic tube 3, and bell 4 for any of a wide range of vehicles. The invention is ambidextrous in design so can be rotated to either side of the garage to minimize space consumption and be placed nearest to either garage wall. The embodiment described here is for use on the left side or driver side of the vehicle. By rotating the invention it can be used on the right side or passenger side of the vehicle using the same entry and exit process. As the vehicle is rectangular in shape either placement will result in the same benefit. The right side orientation has not been shown to avoid any confusion.

### Definitions

The following terms shall have, for the purposes of this application, the respective meanings set forth below.

Motor Vehicle Categories

Certain motor vehicles can be categorized by vehicle class. The following classes shall be defined consistent with how the classifications were used by the Insurance Institute for Highway Safety for 2007 vehicles: Large Luxury Cars, Midsize Luxury Cars, Large Family Cars, Midsize Moderately Priced Cars, Midsize Inexpensive Cars, Small Cars, Large SUVs, Midsize SUVs, Small SUVs, Large Pickups, Small Pickups, and Passenger Vans. The parking guide can be used with any of these types of vehicles.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed:

1. A vehicle parking guide that signals to a vehicle driver appropriate entry into a parking spot and a parking end point comprising:
an adjustable length floor mat comprising interlocking segments which include a segment with a start sensor and a segment with an end sensor, wherein the start segment is adapted to be positioned toward an entry point for the vehicle, and the end segment adapted to be positioned at the finishing point; and
a sounding device with connections for connecting to the sensors, the sounding device and sensors operating to create a sound audible when vehicle wheels pass over the start sensor to indicate to the driver correct entry and when vehicle wheels reach the end sensor to indicate the vehicle reaching the end point.

2. The parking guide of claim 1, wherein the sensors comprise portions of a pneumatic tube, and wherein the sounding device is connected to the pneumatic tube and sounds on pneumatic pressure pulses.

3. The parking guide of claim 2, wherein the segments between the start segment and the end segment include a protected channel for placing the pneumatic tube, the channel operating the prevent the tube from sounding the sounding device as the vehicle's wheels move between the start and the end sensors.

4. The parking guide of claim 3, wherein the segments and the sensors can be attached such that the protected channel is on the left as seen by the driver, or on the right.

5. The parking guide of claim 2, wherein the start segment and end segment comprise tube guides for securing the loop pneumatic tube in appropriate sensing position.

6. The parking guide of claim 5, wherein the pneumatic tube can be connected to the tube guides without tools.

7. The parking guide of claim 1, wherein one or more of the segments between the start segment and the end segment include bumps to provide the driver a tactile feel that they have maintained correct alignment.

8. The parking guide of claim 1, wherein two or more of the segments are colored to contrast with grey or untinted concrete, such that the interlocking segments provide a visual parking guide.

9. The parking guide of claim 1, wherein two or more of the segments are black or yellow.

10. The parking guide of claim 1, wherein the segments can be interlocked without the use of tools.

11. The parking guide as claimed in claim 1 is ambidextrous in design and can be placed in either left side (driver side) or right side (passenger side) for same functionality.

12. A method of parking using the parking guide of claim 1, comprising aligning one of the front wheels with the parking guide; aligning the vehicle with the parking guide and driving forward; hearing the start sound as the aligned front wheel passes over the start sensor; maintaining the aligned orientation and driving until the driver hears the end sensor.

13. The method of claim 12, wherein the a sufficient number of the segments between the start segment and the end segment include bumps such that the driver is provided with a tactile confirmation that the vehicle is correctly oriented.

14. The method of claim 12, wherein start and end sensor are positioned such that three sounds emit on parking with proper alignment, namely in order on front wheel activation of the start sensor, on rear wheel activation of the start sensor, and on front wheel activation of the end sensor.

15. A method of reversing a car out of a parking space while avoiding obstacles using the parking guide of claim 7, comprising:
providing a vehicle parked on the parking guide with two of its wheels on one side aligned with the parking guide;
reversing the vehicle maintaining wheel alignment with the parking guide;
feeling a tactile feel as the vehicle wheels contact the bumps, thereby confirming the maintenance of correct alignment; and
hearing the sound as the aligned front wheel activates the start sensor, further confirming alignment.

16. The method of reversing a car of claim 15, further comprising:
prior to hearing the front tire activation of the start sensor, hearing the back tire activating the start sensor, providing further confirmation of vehicle alignment.
